(19) United States
(12) Patent Application Publication
(10) Pub. No.: US 2023/0224483 A1
(43) Pub. Date: Jul. 13, 2023

(54) IMAGE ENCODING/DECODING METHOD AND APPARATUS FOR SIGNALING PICTURE OUTPUT INFORMATION, AND COMPUTER-READABLE RECORDING MEDIUM IN WHICH BITSTREAM IS STORED

(71) Applicant: LG ELECTRONICS INC., Seoul (KR)

(72) Inventors: Hyeong Moon JANG, Seoul (KR); Hendry HENDRY, Seoul (KR); JungHak NAM, Seoul (KR)

(21) Appl. No.: 18/009,581

(22) PCT Filed: Jun. 9, 2021
(86) PCT No.: PCT/KR2021/007199

§ 371 Date: Dec. 9, 2022

Related U.S. Application Data
(60) Provisional application No. 63/042,001, filed on Jun. 21, 2020.
(60) Provisional application No. 63/036,977, filed on Jun. 9, 2020.

(51) Int. Cl. H04N 19/423; H04N 19/105; H04N 19/172

(52) U.S. Cl. CPC H04N 19/423; H04N 19/105; H04N 19/172

(57) ABSTRACT

An image encoding/decoding method and apparatus for signaling picture output information and a recording medium storing a bitstream are provided. An image decoding method may comprise obtaining picture output information indicating whether a picture included in an output layer in a bitstream is output and performing processing in a DPB of the picture based on the picture output information. The picture output information of a first value may indicate output of the picture and the picture output information of a second value may indicate non-output of the picture. The bitstream may be restricted so that the output layer in the bitstream includes at least one picture whose picture output information is the first value.

### TECHNICAL FIELD

The present disclosure relates to an image encoding/decoding method and apparatus, and, more particularly, to an image encoding/decoding method and apparatus for signaling picture output information, and a computer-readable recording medium storing a bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an image encoding/decoding method and apparatus capable of preventing problems which may occur by inaccurate signaling of picture output information.

Another object of the present disclosure is to provide a method of transmitting a bitstream generated by an image encoding method or apparatus according to the present disclosure.

Another object of the present disclosure is to provide a recording medium storing a bitstream generated by an image encoding method or apparatus according to the present disclosure.

Another object of the present disclosure is to provide a recording medium storing a bitstream received, decoded and used to reconstruct an image by an image decoding apparatus according to the present disclosure.

The technical problems solved by the present disclosure are not limited to the above technical problems and other technical problems which are not described herein will become apparent to those skilled in the art from the following description.

### Technical Solution

An image decoding method performed by an image decoding apparatus according to an aspect of the present disclosure may comprise obtaining picture output information indicating whether a picture included in an output layer in a bitstream is output and performing processing in a DPB of the picture based on the picture output information. The picture output information of a first value may indicate output of the picture and the picture output information of a second value may indicate non-output of the picture. The bitstream may be restricted so that the output layer in the bitstream includes at least one picture whose picture output information is the first value.

In the image decoding method according to the present disclosure, the picture output information may be included and signaled in a picture header for the picture.

In the image decoding method according to the present disclosure, the image decoding method may further comprise obtaining reference picture information indicating whether the picture is able to be used as a reference picture. The reference picture information of a first value may indicate that the picture is not used as a reference picture, the reference picture information of a second value may indicate that the picture is able to be used as a reference picture, and the picture output information may be restricted to have the first value based on the reference picture information being the first value.

In the image decoding method according to the present disclosure, the picture output information may have the first value or the second value, based on the reference picture information being the second value.

An image decoding apparatus according to another aspect of the present disclosure may comprise a memory and at least one processor. The at least one processor may obtain picture output information indicating whether a picture included in an output layer in a bitstream is output and perform processing in a DPB of the picture based on the picture output information. The picture output information of a first value may indicate output of the picture and the picture output information of a second value may indicate non-output of the picture. The bitstream may be restricted so that the output layer in the bitstream includes at least one picture whose picture output information is the first value.

An image encoding method performed by an image encoding apparatus according to another aspect of the present disclosure may comprise determining and encoding picture output information indicating whether a picture included in an output layer in a bitstream is output and performing processing in a DPB of the picture based on the picture output information. The picture output information of a first value may indicate output of the picture and the picture output information of a second value may indicate non-output of the picture. The bitstream may be restricted so that the output layer in the bitstream includes at least one picture whose picture output information is the first value.

In the image encoding method according to the present disclosure, the picture output information may be encoded in a picture header for the picture.

In the image encoding method according to the present disclosure, the image encoding method may further comprise determining and encoding reference picture information indicating whether the picture is able to be used as a reference picture. The reference picture information of a first value may indicate that the picture is not used as a reference picture, the reference picture information of a second value may indicate that the picture is able to be used as a reference picture, and the picture output information may be restricted to have the first value based on the reference picture information being the first value.

In the image encoding method according to the present disclosure, the picture output information may have the first value or the second value, based on the reference picture information being the second value.

Also, a transmission method according to another aspect of the present disclosure may transmit a bitstream generated by an image encoding apparatus or method of the present disclosure.

In addition, a computer-readable recording medium according to another aspect of the present disclosure may store the bitstream generated by the image encoding apparatus or the image encoding method of the present disclosure.

Also, according to the present disclosure, it is possible to provide a recording medium storing a bitstream received, decoded and used to reconstruct an image by an image decoding apparatus according to the present disclosure.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

Also, according to the present disclosure, it is possible to provide an image encoding/decoding method and apparatus capable of preventing problems which may occur by inaccurate signaling of picture output information.

Also, according to the present disclosure, it is possible to provide a method of transmitting a bitstream generated by an image encoding method or apparatus according to the present disclosure.

Also, according to the present disclosure, it is possible to provide a recording medium storing a bitstream generated by an image encoding method or apparatus according to the present disclosure.

Also, according to the present disclosure, it is possible to provide a recording medium storing a bitstream received, decoded and used to reconstruct an image by an image decoding apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a view schematically showing a video coding system, to an embodiment of the present disclosure is applicable.

FIG. 2 is a view schematically showing an image encoding apparatus, to which an embodiment of the present disclosure is applicable.

FIG. 3 is a view schematically showing an image decoding apparatus, to which an embodiment of the present disclosure is applicable.

FIG. 4 is a flowchart illustrating a picture decoding procedure, to which embodiment(s) of the present disclosure is applicable.

FIG. 5 is a flowchart illustrating a picture encoding procedure, to which an embodiment of the present disclosure is applicable.

FIG. 6 is a view illustrating a layer structure for a coded image.

FIG. 7 is a view illustrating a portion of a picture header related to the present disclosure.

FIG. 8 is a flowchart illustrating an image encoding method according to an embodiment of the present disclosure.

FIG. 9 is a flowchart illustrating an image decoding method according to an embodiment of the present disclosure.

FIG. 10 is a view showing a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

A “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, “A or B” may mean “only A”, “only B” or “both A and B”. In other words, in the present disclosure, “A or B” may be interpreted as “A and/or B”. For example, in the present disclosure “A, B or C” means “only A”, “only B”, “only C”, or “any combination of A, B and C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, in the present disclosure, the expression “at least one of A or B” or “at least one of A and/or B” may be interpreted to be equal to “at least one of A and B (at least one of A and B)”.

In addition, in the present disclosure, “at least one of A, B and C” means “only A”, “only B”, “only C”, or any combination of “A, B and C”. Also, “at least one of A, B or C” or “at least one of A, B and/or C” may mean “at least one of A, B and C”.

Also, parentheses used in the present disclosure may mean “for example”. Specifically, when “prediction (intra prediction)” is indicated, “intra prediction” may be suggested as an example of “prediction”. In other words, “prediction” of the present disclosure is not limited to “intra prediction”, and “intra prediction” may be suggested as an example of “prediction”. Also, even when “prediction (i.e., intra prediction)” is indicated, “intra prediction” may be suggested as an example of “prediction”.

In the present disclosure, technical features individually described in one drawing may be implemented individually or simultaneously.

### Overview of Video Coding System

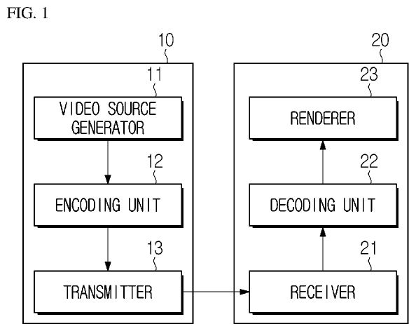

FIG. 1 is a view showing a video coding system according to the present disclosure.

The video coding system according to an embodiment may include an encoding device 10 and a decoding device 20. The encoding device 10 may deliver encoded video and/or image information or data to the decoding device 20 in the form of a file or streaming via a digital storage medium or network.

The source device 10 according to an embodiment may include a video source generator 11, an encoding unit 12 and a transmitter 13. The decoding device 20 according to an embodiment may include a receiver 21, a decoding unit 22 and a renderer 23. The encoding unit 12 may be called a video/image encoding device, and the decoding unit 22 may be called a video/image decoding device. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding device 20 through a digital storage medium or a network in the form of a file or streaming The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

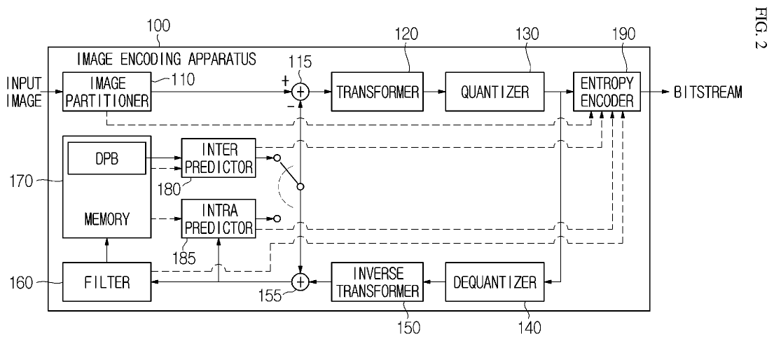

FIG. 2 is a view schematically showing an image encoding apparatus, to which an embodiment of the present disclosure is applicable.

As shown in FIG. 2, the image encoding device 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding device 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding device 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding device 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding device 100, prediction mismatch between the image encoding device 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

### Overview of Image Decoding Apparatus

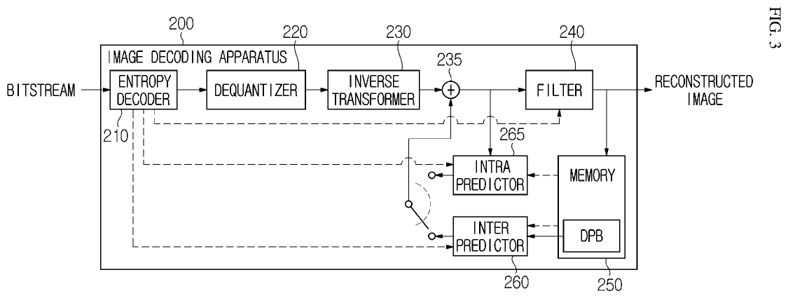

FIG. 3 is a view schematically showing an image decoding apparatus, to which an embodiment of the present disclosure is applicable.

As shown in FIG. 3, the image decoding device 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding device 200 may be configured by a hardware component (e.g., a decoder or a processor) according to an embodiment. In addition, the memory 250 may include a decoded picture buffer (DPB) or may be configured by a digital storage medium.

The image decoding device 200, which has received a bitstream including video/image information, may reconstruct an image by performing a process corresponding to a process performed by the image encoding device 100 of FIG. 2. For example, the image decoding device 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding device 200 may be reproduced through a reproducing apparatus (not shown).

The image decoding device 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding device 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 160 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding device 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding device 100 may be equally or correspondingly applied to the filter 240, the inter prediction unit 260, and the intra prediction unit 265 of the image decoding device 200.

### General Image/Video Coding Procedure

In image/video coding, a picture configuring an image/video may be encoded/decoded according to a decoding order. A picture order corresponding to an output order of the decoded picture may be set differently from the decoding order, and, based on this, not only forward prediction but also backward prediction may be performed during inter prediction.

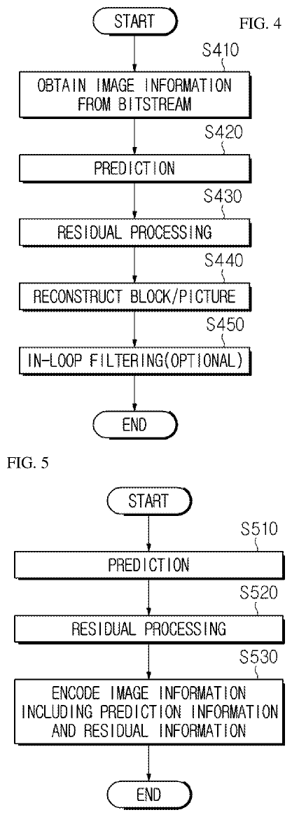

FIG. 4 is a flowchart illustrating a picture decoding procedure, to which embodiment(s) of the present disclosure is applicable.

Each procedure shown in FIG. 4 may be performed by the image decoding apparatus of FIG. 3. For example, step S410 may be performed by the entropy decoder 210, step S420 may be performed by a predictor including the predictors 265 and 260, step S430 may be performed by a residual processor 220 and 230, step S440 may be performed by the adder 235, and step S450 may be performed by the filter 240. Step S410 may include the information decoding procedure described in the present disclosure, step S420 may include the inter/intra prediction procedure described in the present disclosure, step S430 may include a residual processing procedure described in the present disclosure, step S440 may include the block/picture reconstruction procedure described in the present disclosure, and step S450 may include the in-loop filtering procedure described in the present disclosure.

Referring to FIG. 4, the picture decoding procedure may schematically include a procedure (S410) for obtaining image/video information (through decoding) from a bitstream, a picture reconstruction procedure (S420 to S440) and an in-loop filtering procedure (S450) for a reconstructed picture. The picture reconstruction procedure may be performed based on prediction samples and residual samples obtained through inter/intra prediction (S420) and residual processing (S430) (dequantization and inverse transform of the quantized transform coefficient) described in the present disclosure. A modified reconstructed picture may be generated through the in-loop filtering procedure for the reconstructed picture generated through the picture reconstruction procedure. In this case, the modified reconstructed picture may be output as a decoded picture, stored in a decoded picture buffer (DPB) of a memory 250 and used as a reference picture in the inter prediction procedure when decoding the picture later. The in-loop filtering procedure (S450) may be omitted. In this case, the reconstructed picture may be output as a decoded picture, stored in a DPB of a memory 250, and used as a reference picture in the inter prediction procedure when decoding the picture later. The in-loop filtering procedure (S450) may include a deblocking filtering procedure, a sample adaptive offset (SAO) procedure, an adaptive loop filter (ALF) procedure and/or a bi-lateral filter procedure, as described above, some or all of which may be omitted. In addition, one or some of the deblocking filtering procedure, the sample adaptive offset (SAO) procedure, the adaptive loop filter (ALF) procedure and/or the bi-lateral filter procedure may be sequentially applied or all of them may be sequentially applied. For example, after the deblocking filtering procedure is applied to the reconstructed picture, the SAO procedure may be performed. Alternatively, after the deblocking filtering procedure is applied to the reconstructed picture, the ALF procedure may be performed. This may be similarly performed even in the encoding apparatus.

FIG. 5 is a flowchart illustrating a picture encoding procedure, to which an embodiment of the present disclosure is applicable.

Each procedure shown in FIG. 5 may be performed by the image encoding apparatus of FIG. 2. For example, step S510 may be performed by the predictors 185 and 180, step S520 may be performed by a residual processor 115, 120 and 130, and step S530 may be performed in the entropy encoder 190. Step S510 may include the inter/intra prediction procedure described in the present disclosure, step S520 may include the residual processing procedure described in the present disclosure, and step S530 may include the information encoding procedure described in the present disclosure.

Referring to FIG. 5, the picture encoding procedure may schematically include not only a procedure for encoding and outputting information for picture reconstruction (e.g., prediction information, residual information, partitioning information, etc.) in the form of a bitstream but also a procedure for generating a reconstructed picture for a current picture and a procedure (optional) for applying in-loop filtering to a reconstructed picture. The encoding apparatus may derive (modified) residual samples from a quantized transform coefficient through the dequantizer 140 and the inverse transformer 150, and generate the reconstructed picture based on the prediction samples which are output of step S510 and the (modified) residual samples. The reconstructed picture generated in this way may be equal to the reconstructed picture generated in the decoding apparatus. The modified reconstructed picture may be generated through the in-loop filtering procedure for the reconstructed picture. In this case, the modified reconstructed picture may be stored in the decoded picture buffer of a memory 170, and may be used as a reference picture in the inter prediction procedure when encoding the picture later, similarly to the decoding apparatus. As described above, in some cases, some or all of the in-loop filtering procedure may be omitted. When the in-loop filtering procedure is performed, (in-loop) filtering related information (parameter) may be encoded in the entropy encoder 190 and output in the form of a bitstream, and the decoding apparatus may perform the in-loop filtering procedure using the same method as the encoding apparatus based on the filtering related information.

Through such an in-loop filtering procedure, noise occurring during image/video coding, such as blocking artifact and ringing artifact, may be reduced and subjective/objective visual quality may be improved. In addition, by performing the in-loop filtering procedure in both the encoding apparatus and the decoding apparatus, the encoding apparatus and the decoding apparatus may derive the same prediction result, picture coding reliability may be increased and the amount of data to be transmitted for picture coding may be reduced.

As described above, the picture reconstruction procedure may be performed not only in the image decoding apparatus but also in the image encoding apparatus. A reconstructed block may be generated based on intra prediction/inter prediction in units of blocks, and a reconstructed picture including reconstructed blocks may be generated. When a current picture/slice/tile group is an I picture/slice/tile group, blocks included in the current picture/slice/tile group may be reconstructed based on only intra prediction. On the other hand, when the current picture/slice/tile group is a P or B picture/slice/tile group, blocks included in the current picture/slice/tile group may be reconstructed based on intra prediction or inter prediction. In this case, inter prediction may be applied to some blocks in the current picture/slice/tile group and intra prediction may be applied to the remaining blocks. The color component of the picture may include a luma component and a chroma component and the methods and embodiments of the present disclosure are applicable to both the luma component and the chroma component unless explicitly limited in the present disclosure.

### Example of Coding Layer Structure

A coded video/image of the present disclosure may be processed according to, for example, a coding layer and structure to be described later.

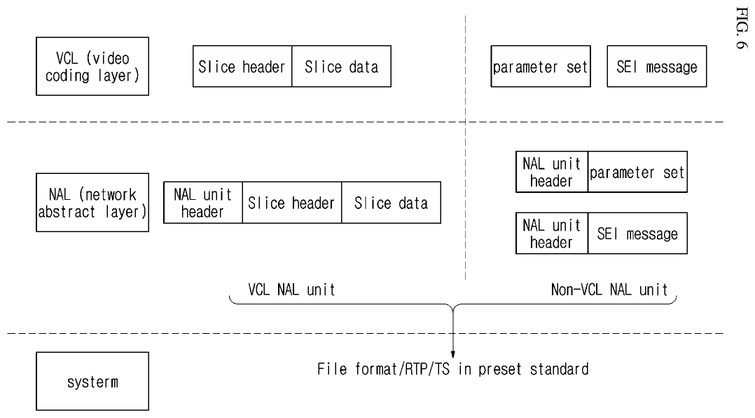

FIG. 6 is a view illustrating a layer structure for a coded video/image. The coded image is classified into a video coding layer (VCL) for an image decoding process and handling itself, a lower system for transmitting and storing encoded information, and a network abstraction layer (NAL) present between the VCL and the lower system and responsible for a network adaptation function.

In the VCL, VCL data including compressed image data (slice data) may be generated or a parameter set including information such as a picture parameter set (PPS), a sequence parameter set (SPS) or a video parameter set (VPS) or a supplemental enhancement information (SEI) message additionally required for a decoding process of an image may be generated.

In the NAL, header information (NAL unit header) may be added to a raw byte sequence payload (RBSP) generated in the VCL to generate a NAL unit. In this case, the RBSP refers to slice data, a parameter set, an SEI message generated in the VCL. The NAL unit header may include NAL unit type information specified according to RBSP data included in a corresponding NAL unit.

As shown in FIG. 6, the NAL unit may be classified into a VCL NAL unit and a non-VCL NAL unit according to a type of the RBSP generated in the VCL. The VCL NAL unit may mean a NAL unit including information on an image (slice data), and the Non-VCL NAL unit may mean a NAL unit including information (parameter set or SEI message) required to decode an image.

The VCL NAL unit and the Non-VCL NAL unit may be attached with header information and transmitted through a network according to the data format of the lower system. For example, the NAL unit may be modified into data having a predetermined data format, such as H.266/VVC file format, RTP (Real-time Transport Protocol) or TS (Transport Stream), and transmitted through various networks.

As described above, in the NAL unit, a NAL unit type may be specified according to the RBSP data structure included in the corresponding NAL unit, and information on the NAL unit type may be stored in a NAL unit header and signaled. For example, this may be broadly classified into a VCL NAL unit type and a non-VCL NAL unit type based on whether the NAL unit includes information on an image (slice data). The VCL NAL unit type may be classified according to a property and type of a picture, and the Non-VCL NAL unit type may be classified according to a type of a parameter set.

An example of the NAL unit type specified according to the type of the parameter set/information included in the Non-VCL NAL unit type will be listed below.
DCI (Decoding capability information) NAL unit type (NUT): Type for NAL unit including DCI
VPS (Video Parameter Set) NUT: Type for NAL unit including VPS
SPS (Sequence Parameter Set) NUT: Type for NAL unit including SPS
PPS (Picture Parameter Set) NUT: Type for NAL unit including PPS
APS (Adaptation Parameter Set) NUT: Type for NAL unit including APS
PH (Picture header) NUT: Type for NAL unit including PH

The above-described NAL unit types may have syntax information on the NAL unit types, and the syntax information may be stored in a NAL unit header and signaled. For example, the syntax information may include nal_unit_type, and the NAL unit types may be specified by a value of nal_unit_type.

Meanwhile, as described above, one picture may include a plurality of slices, and one slice may include a slice header and slice data. In this case, one picture header may be further added to a plurality of slices (slice header and slice data set) in one picture. The picture header (picture header syntax) may include information/parameters commonly applicable to the picture. The slice header (slice header syntax) may include information/parameters commonly applicable to the slice. The APS (APS syntax) or PPS (PPS syntax) may include information/parameters commonly applicable to one or more slices or pictures. The SPS (SPS syntax) may include information/parameters commonly applicable to one or more sequences. The VPS (VPS syntax) may information/parameters commonly applicable to multiple layers. The DCI (DCI syntax) may include information/parameters related to decoding capability.

In the present disclosure, a high level syntax (HLS) may include at least one of the APS syntax, the PPS syntax, the SPS syntax, the VPS syntax, the DCI syntax, the picture header syntax or the slice header syntax. In addition, in the present disclosure, a low level syntax (LLS) may include, for example, a slice data syntax, a CTU syntax, a coding unit syntax, a transform unit syntax, etc.

In the present disclosure, image/video information encoded by the encoding apparatus and signaled to the decoding apparatus in the form of a bitstream may include not only in-picture partitioning related information, intra/inter prediction information, residual information, in-loop filtering information but also information on the slice header, information on the picture header, information on the APS, information on the PPS, information on the SPS, information on the VPS and/or information on the DCI. In addition, the image/video information may further include general constraint information and/or information on a NAL unit header.

### High Level Syntax Signaling and Semantics

As described above, image/video information according to the present disclosure may include High Level Syntax (HLS). An image encoding method and/or an image decoding method may be performed based on the image/video information.

### Picture Header and Slice Header Signaling

A coded picture may consist of one or more slices. Parameters describing a coded picture may be signaled in a picture header (PH). Also, parameters describing a slice may be signaled in a slice header (SH). PH may be included in a dedicated NAL unit type and transmitted. SH may be present at a start location of a NAL unit storing slice payload (i.e., slice data).

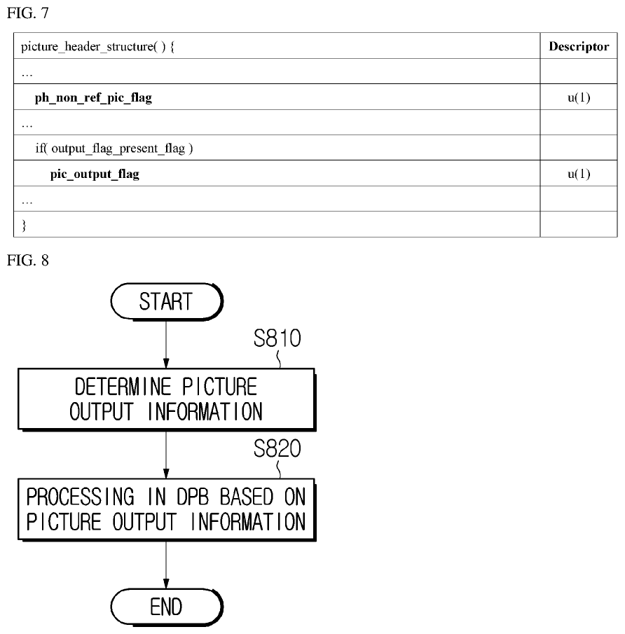

FIG. 7 is a view illustrating a portion of a picture header related to the present disclosure.

In the example shown in FIG. 7, a picture header may include pic_output_flag. As a signaling condition of pic_output_flag, a value of output_flag_present_flag may be considered. However, the signaling condition of pic_output_flag is not limited thereto, and other conditions may be considered instead of output_flag_present_flag or other conditions may be considered together with output_flag_present_flag. Alternatively, pic_output_flag may always be signaled without conditions.

In the example shown in FIG. 7, output_flag_present_flag may be information indicating whether pic_output_flag is present in a bitstream. For example, output_flag_present_flag of a first value (e.g., 1) may indicate that pic_output_flag is present. In addition, output_flag_present_flag of a second value (e.g., 0) may indicate that pic_output_flag is not present.

pic_output_flag may be an example of “picture output information” of the present disclosure. In the present disclosure, pic_output_flag may be indicated by ph_pic_output_flag. In this case, “ph_” may mean that the syntax element pic_output_flag is signaled through a picture header (PH). pic_output_flag may be used for output and removal operation of a decoded picture in a DPB. When pic_output_flag is not present in a bitstream, the value thereof may be inferred to be a first value (e.g., 1). pic_output_flag of a first value (e.g., 1) may indicate that the picture is output. pic_output_flag of a second value (e.g., 0) may indicate that the picture is not output.

As shown in FIG. 7, the picture header may include ph_non_ref_pic_flag. ph_non_ref_pic_flag may be an example of “reference picture information” of the present disclosure. ph_non_ref_pic_flag may enable a system-level entity to know whether a current picture may be used as a reference of other pictures. The system-level entity may remove the picture (that is, the picture not used as a reference of other pictures) based on ph_non_ref_pic_flag in a specific situation. For example, when network congestion occurs, a media-aware network router may drop network packets transmitting coded bits (data) of a picture marked as unused as a reference of other pictures.

ph_non_ref pic_flag of a first value (e.g., 1) may indicate that a picture related to a PH (i.e., a picture header containing ph_non_ref pic_flag) is not used as a reference picture. ph_non_ref_pic_flag of a second value (e.g., 0) may indicate that the picture related to the PH may or may not be used as a reference picture.

In the current video codec standard, when coding a still picture, a bitstream may support only a single layer. However, there are use cases in which a still picture having scalability is useful. For example, a still picture having scalability may adaptively support different quality according to network bandwidth capabilities.

Various configurations of the present disclosure for solving the problem(s) described in the present disclosure will be described below. Configurations described below may be applied alone or in combination of two or more configurations.

Configuration 1: A still picture bitstream may contain one access unit instead of one picture. In this case, the still picture bitstream may conform to main 10 still picture profile or main 4:4:4 10 still picture profile.

Configuration 2: An access unit in a still picture bitstream may contain a single layer or multiple layers. When the still picture bitstream has a single layer, it may mean that each access unit of the bitstream contains only one picture. When the still picture bitstream has multiple layers, it may mean that the access unit of the bitstream contains multiple pictures.

Configuration 3: When the still picture bitstream has multiple layers, each layer may be independently decoded. Alternatively, one or more layers in the bitstream may be dependent on other layers.

Configuration 4: When a VPS (Video Parameter Set) is present (that is, the value of sps_video_parameter_set_id is greater than 0), one or more output layer sets (OLSs) containing layers in the bitstream may be specified in a VPS. For example, when the bitstream contains only one layer and the value of sps_video_parameter_set_id is greater than 0, an OLS containing only one layer shall be specified in the VPS. This may be expressed as another restriction (e.g., a restriction that the value of sps_ptl_dpb_hrd_params_present_flag shall be equal to 1) that specifies that at least profile, tier and level information is present in a sequence parameter set (SPS). Alternatively, when the bitstream contains multiple layers, sps_video_parameter_set_id shall be greater than 0 and at least one OLS containing all layers in the bitstream shall be specified in the VPS.

Configuration 5: As an alternative to Configuration 4, it may be restricted so that there is not VPS for a still picture bitstream. For example, the value of sps_video_parameter_set_id may be limited to 0.

Configuration 6: When the still picture bitstream contains multiple layers, the number of decoded picture buffers in a DPB shall be equal to or greater than a value obtained by adding 1 to a maximum number of direct reference layers of another layer in the bitstream. The reason for adding 1 is to consider a picture buffer of a current picture itself. In other words, the number of decoded picture buffers in the DPB shall not be less than a value obtained by adding 1 to the maximum number of direct reference layers of another layer in the bitstream.

Configuration 7: When the still picture bitstream contains multiple layers, decoded picture buffers shall be supported up to the number of reference layers plus 1, including the current picture itself.

Configuration 8: When the still picture bitstream contains multiple layers, the decoded picture buffer shall have as many picture buffers as the number of reference layers plus 1, including the current picture itself.

Configuration 9: Alternatively, when the still picture bitstream contains multiple layers, one OLS containing the layers present in the bitstream shall be present in the VPS, and the OLS shall have only one output layer.

Configuration 10: In addition to Configuration 9, a picture in the still picture bitstream shall has PictureOutputFlag of 1. This means that the picture belongs to an output layer and the value of ph_pic_output_flag shall be 1. In this case, ph_pic_output_flag may be present in a picture header and, if not present, the value thereof may be inferred.

Configuration 11: Alternatively, a valid bitstream may include at least one layer as an output layer, and at least one picture in the layer may be restricted so that PictureOutputFlag is equal to 1. The above restrictions may be applied to bitstreams of other profiles as well as the still picture bitstream.

The aforementioned PictureOutputFlag is an internal variable indicating whether to output a picture, and the value thereof may be set to a value of ph_pic_output_flag signaled in a picture header or a value of ph_pic_output_flag that is inferred.

Hereinafter, an embodiment of the present disclosure will be described.

As described with reference to FIG. 7, a picture header related to a picture may signal ph_non_ref_pic_flag and/or ph_pic_output_flag (or pic_output_flag) for the picture.

As described above, ph_pic_output_flag may be used for output and removal operation of a decoded picture in a DPB. In addition, when ph_pic_output_flag is not present in a bitstream, the value thereof may be inferred to be a first value (e.g., 1). ph_pic_output_flag of a first value (e.g., 1) may indicate that the picture is output. ph_pic_output_flag of a second value (e.g., 0) may indicate that the picture is not output (non-output).

ph_pic_output_flag may be restricted to have a predetermined value according to the value of ph_non_ref pic_flag. More specifically, when ph_non_ref pic_flag of a certain picture is a first value (e.g., 1), ph_pic_output_flag of the picture may be restricted to have a first value (e.g., 1). This may mean that, when the picture is not used as a reference picture of another picture, it shall be output. Since a picture which is neither used nor output as a reference picture does not need to be transmitted, the above restrictions may be to prevent transmission of unnecessary picture data.

However, when ph_non_ref pic_flag is a second value (e.g., 0), there is no restriction on the value of ph_pic_output_flag. Accordingly, when ph_non_ref pic_flag is a second value (e.g., 0), ph_pic_output_flag may have a first value (e.g., 1) or a second value (e.g., 0).

According to the embodiment described with reference to FIG. 7, ph_non_ref_pic_flag may be included in all picture headers and signaled without a separate signaling condition. In addition, there is no restriction that ph_non_ref pic_flag shall have a certain value under a certain condition.

According to the above description in relation to ph_pic_output_flag and ph_non_ref_pic_flag, the following problems may occur.

For example, ph_non_ref_pic_flag for all picture in the output layer may be a second value (e.g., 0). In addition, as described above, when ph_non_ref_pic_flag is a second value (e.g., 0), ph_pic_output_flag may have a first value (e.g., 1) or a second value (e.g., 0) without any restriction. Accordingly, a case where ph_pic_output_flag for all picture in the output layer is a second value (e.g., 0) may occur. This causes serious errors in which all pictures in the output layer are not output.

Embodiments of the present disclosure may additionally include the following restrictions in consideration of the above problems.

ph_pic_output_flag for at least one of one or more pictures in the output layer included in an output layer set (OLS) may be restricted to have a first value (e.g., 1).

Alternatively, ph_pic_output_flag for at least one of one or more pictures in the output layer included in the bitstream may be restricted to have a first value (e.g., 1).

Alternatively, ph_pic_output_flag for at least one of one or more pictures in the output layer included in a coded video sequence (CVS) may be restricted to have a first value (e.g., 1).

The restriction is a requirement for a bitstream, and may be substantially the same as restricting the bitstream to include a picture in at least one output layer having ph_pic_output_flag of a first value (e.g., 1).

According to an embodiment of the present disclosure, since at least one of one or more pictures in the output layer has ph_pic_output_flag of a first value (e.g., 1), the above-described problem that all of the one or more pictures in the output layer are not output may be solved.

FIG. 8 is a flowchart illustrating an image encoding method according to an embodiment of the present disclosure.

An image encoding method according to the present disclosure may be performed by an image encoding apparatus. The image encoding apparatus according to the present disclosure may determine picture output information indicating whether to output a picture included in an output layer in a bitstream (S810). The image encoding apparatus may encode the determined picture output information. Encoding of the determined picture output information may be performed at the time of determining the picture output information or may be performed later. When a predetermined signaling condition for encoding the picture output information is not satisfied, the image encoding apparatus may skip encoding of the picture output information, and, in this case, the picture output information of the picture may be inferred to be a predetermined value. When the picture is output, the picture output information may be determined to be a first value (e.g., 1) and encoded. When the picture is not output, the picture output information may be determined to be a second value (e.g., 0) and encoded.

Before performing step S810, the image encoding apparatus may determine reference picture information indicating whether the picture is able to be used as a reference picture (not shown). Encoding of the determined reference picture information may be performed at the time of determining the reference picture information or may be performed later. When the picture is not used as a reference picture, the reference picture information may be determined to be a first value (e.g., 1) and encoded. When the picture is able to be used as a reference picture, the reference picture information may be determined to be a second value (e.g., 0) and encoded. More specifically, when the picture may or may not be used as a reference picture, the reference picture information may be determined to be a second value (e.g., 0) and encoded. In the present disclosure, the technical meaning that a certain picture may be used as a reference picture may include that the picture may be used as a reference picture for inter-prediction or inter-layer prediction of another picture.

The image encoding apparatus may perform step S810 based on the reference picture information. Specifically, when the reference picture information of a certain picture is a first value (e.g., 1), the image encoding apparatus may determine the picture output information of the picture to be a first value (e.g., 1) in step S810. As a result, the bitstream generated by the image encoding apparatus may implement Restriction 1 below.

Restriction 1: When reference picture information (e.g., ph_non_ref pic_flag) of a certain picture is a first value (e.g., 1), the picture output information (e.g., ph_pic_output_flag) of the picture shall have a first value (e.g., 1).

In addition, when the reference picture information of the certain picture is a second value (e.g., 0), the image encoding apparatus may determine the picture output information of the picture to be a first value (e.g., 1) or a second value (e.g., 0) regardless of the reference picture information.

However, the image encoding apparatus is required to perform step S810 so that Construction 2 below may be implemented.

Restriction 2: The bitstream shall include at least one picture whose picture output information in the output layer in the bitstream is a first value (e.g., 1).

The image encoding apparatus may include the determined picture output information in a picture header for the picture and encode it.

As described above, the picture output information may be used for output and removal operation of a decoded picture in a DPB. The image encoding apparatus may perform processing in the DPB of the picture based on the determined picture output information (S820).

According to the image encoding method of the present disclosure, at least one of one or more pictures of the output layer in the bitstream may be output. Accordingly, the above-mentioned problem that all one or more pictures in the output layer are not output can be solved.

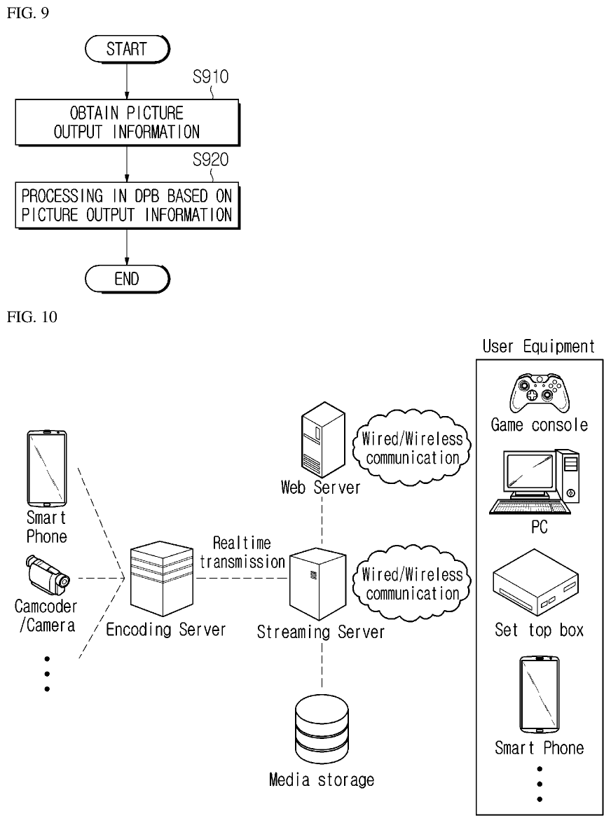

FIG. 9 is a flowchart illustrating an image decoding method according to an embodiment of the present disclosure.

An image decoding method according to the present disclosure may be performed by an image decoding apparatus. The image decoding method according to the present disclosure may receive and decode a bitstream generated by the image encoding method described with reference to FIG. 8. The image decoding apparatus according to the present disclosure may obtain picture output information indicating whether a picture included in an output layer in the bitstream is output (S910). When a predetermined condition for signaling of the picture output information is satisfied, the image decoding apparatus may parse the picture output information from the bitstream. When a predetermined condition for signaling of the picture output information is not satisfied, the image decoding apparatus may skip parsing of the picture output information and infer the picture output information of the picture to be a predetermined value. When the obtained picture output information is a first value (e.g., 1), it may mean that the picture is output. When the obtained picture output information is a second value (e.g., 0), it may mean that the picture is not output.

Before performing step S910, the image decoding apparatus may obtain reference picture information indicating whether the picture is able to be used as a reference picture (not shown). When the obtained reference picture information is a first value (e.g., 1), it may mean that the picture is not used as a reference picture. When the obtained reference picture information is a second value (e.g., 0), it may mean that the picture may be used as a reference picture. More specifically, when the obtained reference picture information is a second value (e.g., 0), it may mean that the picture may or may not be used as a reference picture. In the present disclosure, the technical meaning that one picture may be used as a reference picture may include that the picture may be used as a reference picture for inter-prediction or inter-layer prediction of another picture.

The image decoding apparatus may perform step S910 based on the reference picture information. Specifically, when the reference picture information of a certain picture is a first value (e.g., 1), the image decoding apparatus may determine the picture output information of the picture to be a first value (e.g., 1) in step S910. However, it is not limited thereto, and the image decoding apparatus may obtain the value by parsing or inferring the picture output information from the bitstream regardless of the reference picture information. For example, when a bitstream received by the image decoding apparatus of the present disclosure is a bitstream generated by the image encoding method described with reference to FIG. 8, the bitstream satisfies Restriction 1 below. Therefore, the image decoding apparatus may obtain coded picture output information with an accurate value in step S910 even if it is not based on the reference picture information.

Restriction 1: When reference picture information (e.g., ph_non_ref pic_flag) of a certain picture is a first value (e.g., 1), the picture output information (e.g., ph_pic_output_flag) of the picture shall have a first value (e.g., 1).

In other words, when the bitstream received by the image decoding apparatus is generated by the image encoding method of FIG. 8 and the reference picture information of a certain picture is a first value (e.g., 1), the image decoding apparatus obtains picture output information encoded to a first value (e.g., 1). Accordingly, the image decoding apparatus may obtain accurately the encoded picture output information without considering whether the reference picture information is a first value (e.g., 1) or a second value (e.g., 0).

In addition, when the reference picture information of a certain picture is a second value (e.g., 0), the picture output information of the picture may have a first value (e.g., 1) or a second value (e.g., 0) regardless of the reference picture information. Accordingly, in this case, the image decoding apparatus may obtain the output information of the picture by parsing or inferring it from the bitstream.

The bitstream received by the image decoding apparatus is generated by the image encoding method of FIG. 8 and is required to satisfy Restriction 2 below.

Restriction 2: The bitstream shall include at least one picture whose picture output information in the output layer in the bitstream is a first value (e.g., 1).

The image decoding apparatus may parse the picture output information from a picture header related to the picture.

As described above, the picture output information may be used for output and removal operation of a decoded picture in a DPB. The image decoding apparatus may perform processing in the DPB of the picture based on the obtained picture output information (S920).

According to the image decoding method of the present disclosure, at least one of one or more pictures of the output layer in the bitstream may be output. Accordingly, the above-mentioned problem that all one or more pictures in the output layer are not output can be solved.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

FIG. 10 is a view showing a content streaming system, to which an embodiment of the present disclosure is applicable.

As shown in FIG. 10, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content are received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### Industrial Applicability

The embodiments of the present disclosure may be used to encode or decode an image.

1. An image decoding method performed by an image decoding apparatus, the image decoding method comprising:
obtaining picture output information on a picture included in an output layer in a bitstream being outputted; and
performing processing in a DPB of the picture based on the picture output information,
wherein the picture output information of a first value indicates output of the picture and the picture output information of a second value indicates non-output of the picture, and
wherein the bitstream is restricted so that the output layer in the bitstream includes at least one picture whose picture output information is the first value.

2. The image decoding method of claim 1, wherein the picture output information is included and signaled in a picture header for the picture.

3. The image decoding method of claim 1, further comprising obtaining reference picture information on the picture being available to be used as a reference picture,
wherein the reference picture information of a first value indicates that the picture is not used as a reference picture, the reference picture information of a second value indicates that the picture is available to be used as a reference picture, and the picture output information is restricted to have the first value based on the reference picture information being the first value.

4. The image decoding method of claim 3, wherein the picture output information has the first value or the second value, based on the reference picture information being the second value.

5. An image decoding apparatus comprising a memory and at least one processor,
wherein the at least one processor is configured to:
obtain picture output information on a picture included in an output layer in a bitstream being outputted; and
perform processing in a DPB of the picture based on the picture output information,
wherein the picture output information of a first value indicates output of the picture and the picture output information of a second value indicates non-output of the picture, and
wherein the bitstream is restricted so that the output layer in the bitstream includes at least one picture whose picture output information is the first value.

6. An image encoding method performed by an image encoding apparatus, the image encoding method comprising:
determining and encoding picture output information on a picture included in an output layer in a bitstream being outputted; and
performing processing in a DPB of the picture based on the picture output information,
wherein the picture output information of a first value indicates output of the picture and the picture output information of a second value indicates non-output of the picture, and
wherein the bitstream is restricted so that the output layer in the bitstream includes at least one picture whose picture output information is the first value.

7. The image encoding method of claim 6, wherein the picture output information is encoded in a picture header for the picture.

8. The image encoding method of claim 6, further comprising determining and encoding reference picture information on the picture being available to be used as a reference picture,
wherein the reference picture information of a first value indicates that the picture is not used as a reference picture, the reference picture information of a second value indicates that the picture is available to be used as a reference picture, and the picture output information is restricted to have the first value based on the reference picture information being the first value.

9. The image encoding method of claim 8, wherein the picture output information has the first value or the second value, based on the reference picture information being the second value.

10. A computer-readable recording medium storing a bitstream generated by the image encoding method of claim 6.

11. A computer-readable recording medium storing a bitstream decoded by an image decoding apparatus and used to reconstruct an image,
wherein the bitstream comprises picture output information on a picture included in an output layer in the bitstream being outputted,
wherein the picture output information is used to perform processing in a DPB of the picture,
wherein the picture output information of a first value indicates output of the picture and the picture output information of a second value indicates non-output of the picture, and
wherein the bitstream is restricted so that the output layer in the bitstream includes at least one picture whose picture output information is the first value.

12. The computer-readable recording medium of claim 11, wherein the picture output information is included in a picture header for the picture in the bitstream.

13. The computer-readable recording medium of claim 11,
wherein the bitstream further comprises reference picture information on the picture being available to be used as a reference picture, and
wherein the reference picture information of a first value indicates that the picture is not used as a reference picture, the reference picture information of a second value indicates that the picture is available to be used as a reference picture, and the picture output information is restricted to have the first value based on the reference picture information being the first value.

14. The computer-readable recording medium of claim 13, wherein the picture output information has the first value or the second value, based on the reference picture information being the second value.
